(19) United States
(12) Patent Application Publication
(10) Pub. No.: US 2025/0189752 A1
(43) Pub. Date: Jun. 12, 2025

(54) LENS UNIT AND LENS BARREL

(71) Applicant: CANON KABUSHIKI KAISHA, Tokyo (JP)

(72) Inventor: YUKI OYAMA, Kanagawa (JP)

(21) Appl. No.: 18/972,073

(22) Filed: Dec. 6, 2024

(30) Foreign Application Priority Data
Dec. 7, 2023 (JP) 2023-206966

(51) Int. Cl. G02B 7/02

(52) U.S. Cl. CPC G02B 7/023; G02B 7/021

(57) ABSTRACT

A second lens unit has a second lens holding frame that holds a reference lens among a plurality of lenses, a first adjustment frame that holds a first adjustment lens among the plurality of lenses and is adjustable in a direction orthogonal to an optical axis with respect to the second lens holding frame, and a second adjustment frame that holds a second adjustment lens among the plurality of lenses and is adjustable in the direction orthogonal to the optical axis with respect to the second lens holding frame. The first adjustment frame is arranged on the object side in the optical axis direction with respect to the second lens holding frame. The second adjustment frame is arranged on the image side in the optical axis direction with respect to the second lens holding frame.

### BACKGROUND

### Field

The present disclosure relates to a lens unit and the like, and more particularly to a lens unit and the like used in an imaging apparatus.

### Description of the Related Art

In order to correct misalignment of lenses such as tilt or eccentricity that occurs during the manufacturing process, the lens barrel is provided with optical adjustment mechanisms for eccentricity adjustment and lens spacing adjustment. Eccentricity adjustment is to move the lens to be adjusted in a direction orthogonal to the optical axis with respect to a reference lens.

Japanese Patent Application Laid-Open No. 2007-219405 discusses a lens barrel equipped with two adjustment mechanisms, that is, eccentricity adjustment and tilt adjustment, for a second lens holding frame that holds a second optical element with respect to a first lens holding frame that holds a first optical element.

Japanese Patent Application Laid-Open No. 2004-219608 discusses a lens barrel that has a plurality of lenses and a lens holding frame, in which the lens holding frame is held in a housing via an intermediate tube, and the intermediate tube is equipped with a centering unit for decentering the lens holding frame in a direction orthogonal to the optical axis.

In recent years, captured images have been improved in image quality and pixel count, and stricter positional accuracy has been required against misalignment of the lens that occurs during the manufacturing process of the lens barrel. In response to such requirements, there may be cases where a plurality of lenses included in a lens unit is subjected to independent optical adjustment.

However, the technique discussed in Japanese Patent Application Laid-Open No. 2007-219405 does not provide a configuration for subjecting a plurality of lenses to independent optical adjustment with respect to a reference lens. If adjustment mechanisms for different optical elements are provided, there is a possibility that the lens frame will become large in size.

Japanese Patent Application Laid-Open No. 2004-219608 provides a plurality of lens adjustment mechanisms with respect to a reference lens. However, since the adjustment mechanisms are positioned close to each other, it is necessary to provide space to prevent the adjustment mechanisms from interfering with each other, which can result in upsizing of the overall device.

### SUMMARY

The present disclosure has been made in consideration of the above-described disadvantages, and is directed to improving optical performance without increasing the size.

According to an aspect of the present disclosure, a lens unit having a plurality of lenses includes a holding frame configured to hold a first lens among the plurality of lenses, a first adjustment frame that is configured to hold a first adjustment lens among the plurality of lenses and is adjustable with respect to the holding frame in a direction orthogonal to an optical axis, a second adjustment frame that is configured to hold a second adjustment lens among the plurality of lenses and is adjustable with respect to the holding frame in the direction orthogonal to the optical axis, a first fixing part configured to fix the first adjustment frame to the holding frame, and a second fixing part configured to fix the second adjustment frame to the holding frame, wherein the first adjustment frame is arranged on an object side in an optical axis direction with respect to the holding frame, wherein the second adjustment frame is arranged on an image side in the optical axis direction with respect to the holding frame, and wherein the first fixing part and the second fixing part are arranged so as not to overlap each other as viewed from the optical axis direction.

Further features of the present disclosure will become apparent from the following description of exemplary embodiments with reference to the attached drawings.

### BRIEF DESCRIPTION OF THE DRAWINGS

FIGS. 1A and 1B are exploded perspective views of an imaging apparatus according to an exemplary embodiment.

FIG. 2 is an exploded perspective view of a second lens unit according to the exemplary embodiment.

FIGS. 3A and 3B are cross-sectional views of the second lens unit according to the exemplary embodiment.

FIG. 4 is a front view of the second lens unit and a third lens unit according to the exemplary embodiment.

FIG. 5 is a rear view of the second and third lens units according to the exemplary embodiment.

FIGS. 6A and 6B are partial enlarged views of the second lens unit according to the exemplary embodiment.

### DESCRIPTION OF THE EMBODIMENT

Hereinafter, a preferred exemplary embodiment of the present disclosure will be described in detail with reference to the accompanying drawings.

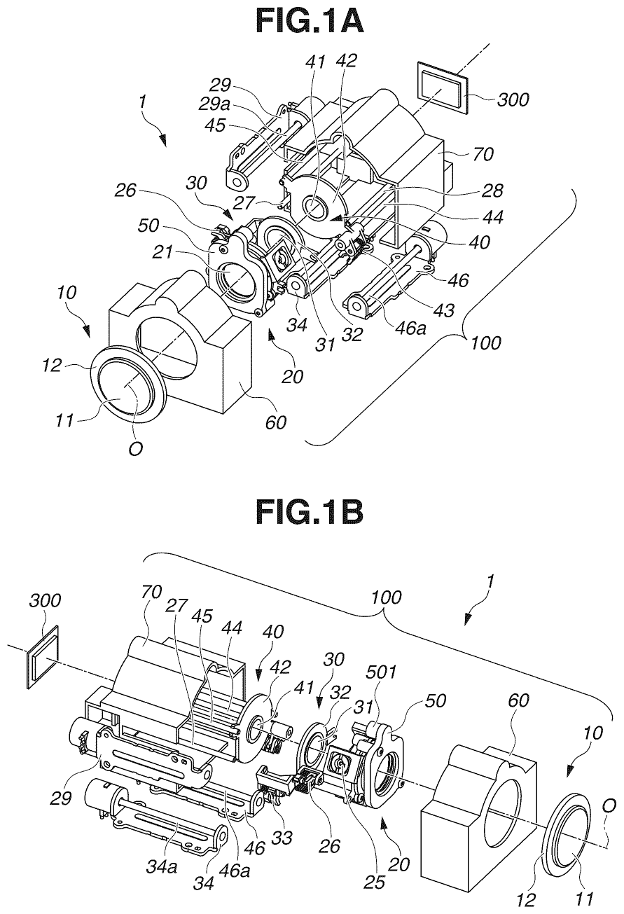

FIGS. 1A and 1B are exploded perspective views of an imaging apparatus 1. FIG. 1A and FIG. 1B are respective perspective views in different directions. In the diagrams including FIGS. 1A and 1B, an optical axis O of the imaging apparatus 1 is indicated by a dash-dotted line. In the optical axis direction, the side of a first lens unit 10 described below will be referred to as object side (or front side), and the side of an imaging element unit 300 described below will be referred to as image side (or rear side).

The imaging apparatus 1 includes a lens barrel 100, an imaging element unit 300, and the like.

The lens barrel 100 of the present exemplary embodiment includes one fixed lens unit and three movable lens units. Specifically, the lens barrel 100 has a first lens unit 10, a second lens unit 20, a third lens unit 30, a fourth lens unit 40, a front housing member 60, and a rear housing member 70.

The first lens unit 10 (first group lens unit) is a lens unit that is fixed in the optical axis direction. The second lens unit 20 (second group lens unit) is a lens unit that moves in the optical axis direction to perform a zooming operation. The third lens unit 30 (third group lens unit) is a lens unit that moves in the optical axis direction to perform a zooming operation. The fourth lens unit 40 (fourth group lens unit) is a lens unit that moves in the optical axis direction to perform a focusing operation.

The first lens unit 10 has a first lens unit 11 and a first lens holding frame 12.

The first lens unit 11 is held by the first lens holding frame 12. The first lens holding frame 12 is fixed to the front housing member 60.

The front housing member 60 and the rear housing member 70 function as a housing for the lens barrel 100. Specifically, the front housing member 60 and the rear housing member 70 store the first lens unit 10, the second lens unit 20, the third lens unit 30, and the fourth lens unit 40, and protect these lens units from external impacts. The front housing member 60 and the rear housing member 70 are fixed and combined together with screws or the like.

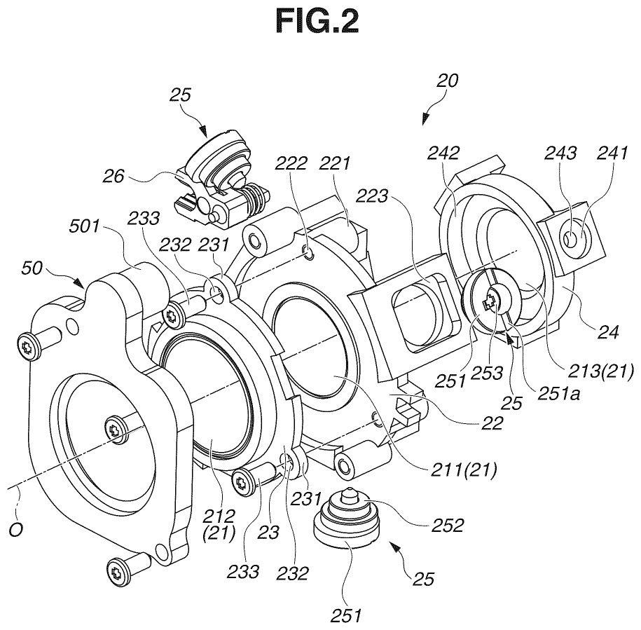

FIG. 2 is an exploded perspective view of the second lens unit 20 (optical adjustment group).

The second lens unit 20 has a second lens unit 21. The second lens unit 21 is a zoom lens unit including a plurality of lenses. Specifically, the second lens unit 21 includes a reference lens 211, a first adjustment lens 212, and a second adjustment lens 213.

The reference lens 211 is held by the second lens holding frame 22.

The first adjustment lens 212 is held by a first adjustment frame 23. The first adjustment frame 23 is held by the second lens holding frame 22. The first adjustment frame 23 is positioned on the object side in the optical axis direction with respect to the second lens holding frame 22. The first adjustment frame 23 is adjustable in a direction orthogonal to the optical axis O with respect to the second lens holding frame 22.

The second adjustment lens 213 is held by a second adjustment frame 24. The second adjustment frame 24 is held by the second lens holding frame 22 via a plurality of adjustment members 25. The second adjustment frame 24 is positioned on the image side in the optical axis direction with respect to the second lens holding frame 22. The second adjustment frame 24 is adjustable in the direction orthogonal to the optical axis O with respect to the second lens holding frame 22.

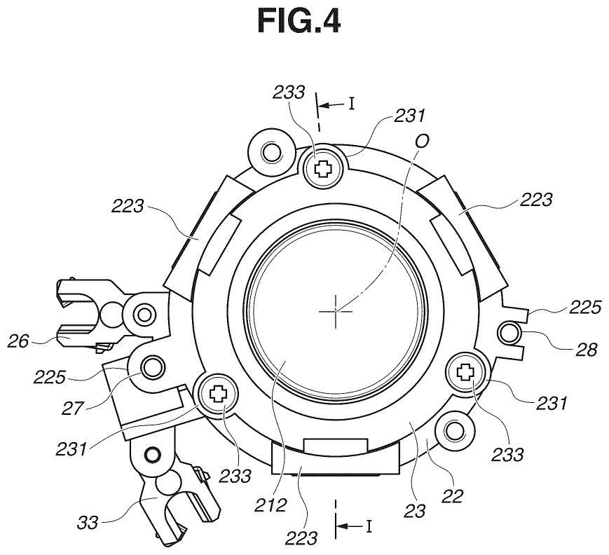

The second lens holding frame 22 engages with an axial second group guiding member 27 (see FIGS. 1A, 1B, and 4) and is supported so as to be capable of advance and retreat (movable) in the optical axis direction. The second lens holding frame 22 also engages with an axial second group rotation restricting member 28 and is supported such that the center of the second lens unit 21 is positioned on the optical axis. The second group guiding member 27 and the second group rotation restricting member 28 are guide bars that guide the second lens holding frame 22 in advancing or retreating in the optical axis direction.

The second lens holding frame 22 rotatably holds a second group rack 26. The second group rack 26 engages with a screw part 29a of a second group driving member 29 (see FIGS. 1A and 1B). Therefore, the second lens holding frame 22 is driven by the second group driving member 29 to advance or retreat together with the second group rack 26 in the optical axis direction.

An aperture unit 50 is fixed to the second lens holding frame 22 and adjusts the amount of light incident on the imaging element unit 300. The aperture unit 50 is driven by an aperture unit driving unit 501 to change its opening size, thereby making it possible to adjust the amount of light taken in from a subject. The aperture unit 50 is electrically connected to a lens driving unit (not illustrated).

Detailed configurations of the second lens holding frame 22, the first adjustment frame 23, the second adjustment frame 24, and the adjustment members 25, and an optical adjustment mechanism using them will be described below.

The third lens unit 30 includes a third lens unit 31 (see FIGS. 1A and 1B).

The third lens unit 31 is a zoom lens that is held by a third lens holding frame 32.

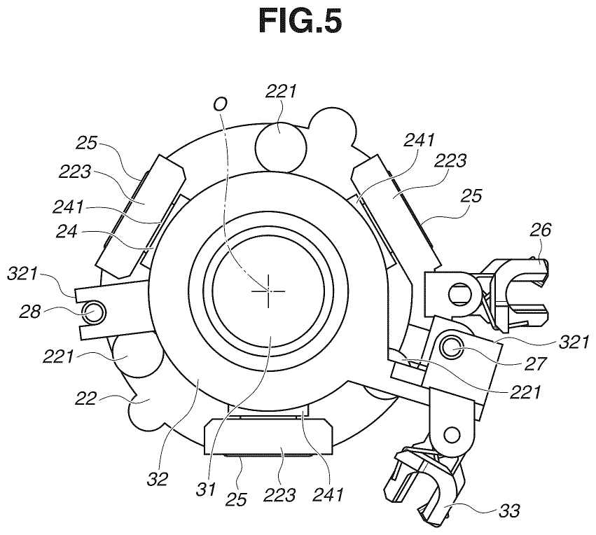

The third lens holding frame 32 engages with the axial second group guiding member 27 (see FIGS. 1A, 1B, and 5) and is supported so as to be capable of advance and retreat (movable) in the optical axis direction. The third lens holding frame 32 also engages with the axial second group rotation restricting member 28 and is supported such that the center of the third lens unit 31 is positioned on the optical axis. That is, the second group guiding member 27 and the second group rotation restricting member 28 guide the third lens holding frame 32 in advancing or retreating in the optical axis direction, as well as the above-described second lens holding frame 22.

The third lens holding frame 32 rotatably holds a third group rack 33 (see FIGS. 1A, 1B, 4, and 5). The third group rack 33 engages with a screw part 34a of a third group driving member 34 (see FIGS. 1A and 1B). Therefore, the third lens holding frame 32 is driven by the third group driving member 34 to advance or retreat together with the third group rack 33 in the optical axis direction.

The fourth lens unit 40 has a fourth lens unit 41 (see FIGS. 1A and 1B).

The fourth lens unit 41 is a focus lens that is held by a fourth lens holding frame 42. The fourth lens holding frame 42 engages with an axial fourth group guiding member 44 and is supported so as to be capable of advance and retreat in the optical axis direction. The fourth lens holding frame 42 also engages with an axial fourth group rotation restricting member 45 and is supported such that the center of the fourth lens unit 41 is positioned on the optical axis.

The fourth lens holding frame 42 rotatably holds a fourth group rack 43. The fourth group rack 43 engages with a screw part 46a of a fourth group driving member 46. Therefore, the fourth lens holding frame 42 is driven by the fourth group driving member 46 to advance or retreat together with the fourth group rack 43 in the optical axis direction.

The imaging element unit 300 is held by the rear housing member 70, receives light guided by the first lens unit 10, the aperture unit 50, and the second lens unit 20 to the fourth lens unit 40, and converts the light into image information.

Next, a detailed configuration of the second lens unit 20 having an optical adjustment mechanism will be described with reference to FIGS. 2 to 6B.

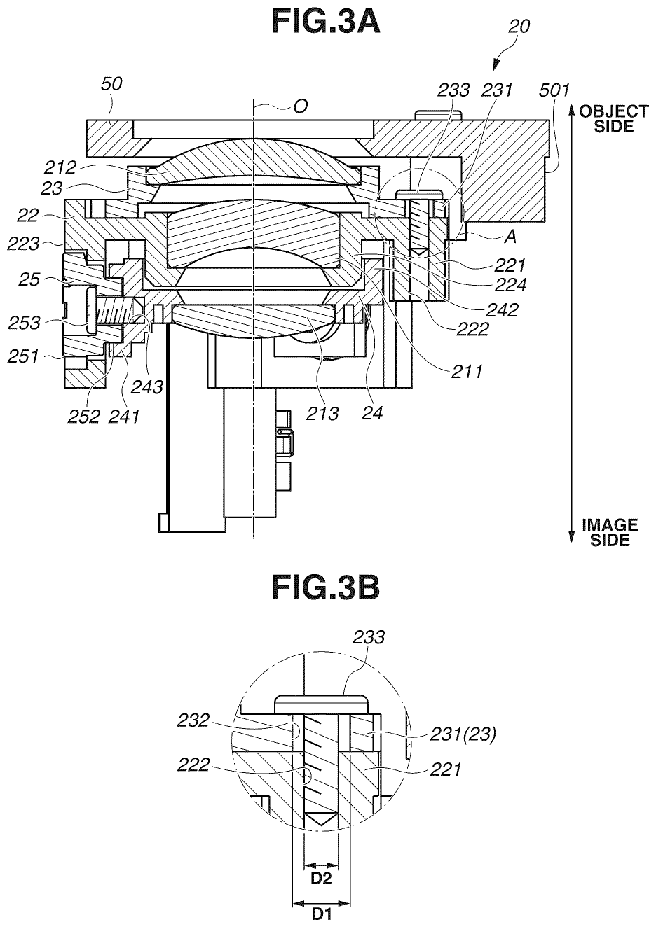

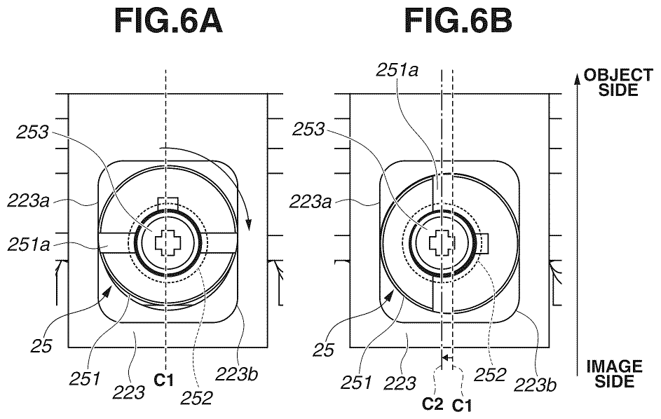

FIG. 3A is a cross-sectional view of the second lens unit 20 (optical adjustment group) taken along the optical axis O and line I-I illustrated in FIG. 4. FIG. 4 is a front view of the second lens unit 20 (optical adjustment group) and the third lens unit 30 as seen from the object side (front side). FIG. 5 is a rear view of the second lens unit 20 (optical adjustment group) and the third lens unit 30 as seen from the image side (rear side). FIGS. 6A and 6B are diagrams illustrating a configuration of the adjustment member 25 of the second lens unit 20 and its surroundings. FIGS. 3A to 6B do not illustrate components that are not necessary for the description.

First, the relationship between the first adjustment frame 23 and the second lens holding frame 22 will be described.

The first adjustment frame 23 that holds the first adjustment lens 212 is held by the second lens holding frame 22 such that the first adjustment lens 212 is arranged closer to the object side than the reference lens 211 in the optical axis direction. As illustrated in FIG. 3A, there is a space formed between the first adjustment frame 23 and the second lens holding frame 22. The space expands in the radial direction centered around the optical axis O.

The first adjustment frame 23 has fastening parts 231 formed close to the outer peripheral edge of the first adjustment frame 23. The fastening parts 231 are an example of a first fixing part for fixing the first adjustment frame 23 to the second lens holding frame 22. Each fastening part 231 has a through hole 232 through which a screw 233 serving as a fastening member is inserted in the optical axis direction. The plurality of fastening parts 231 (three in this example) is arranged at substantially equal intervals on a circumference centered around the optical axis O.

The second lens holding frame 22 has fastening parts 221 formed close to the outer peripheral edge of the second lens holding frame 22. The fastening parts 221 extend in the optical axis direction from the second lens holding frame 22 toward the image side, and each have a female screw portion 222 into which the screw 233 is screwed. The fastening parts 221 have a certain length along the optical axis direction to ensure the length of the female screw portions 222. The plurality of fastening parts 221 (three in this example) is arranged at substantially equal intervals on a circumference centered around the optical axis O. The female screw portions 222 of the fastening parts 221 of the second lens holding frame 22 and the through holes 232 of the first adjustment frame 23 communicate with each other in the optical axis direction.

The screws 233 are inserted from the object side in the optical axis direction into the through holes 232 of the fastening parts 231 of the first adjustment frame 23. The screws 233 inserted into the through holes 232 are fastened to the female screw portions 222 of the fastening parts 221 of the second lens holding frame 22, whereby the first adjustment frame 23 can be fixed to the second lens holding frame 22.

In the present exemplary embodiment, the first adjustment frame 23 is adjustable in the direction orthogonal to the optical axis O with respect to the second lens holding frame 22. That is, before fastening the first adjustment frame 23 to the second lens holding frame 22 with the screws 233, the first adjustment frame 23 can be translated in the direction orthogonal to the optical axis O with respect to the second lens holding frame 22. Translating the first adjustment frame 23 in the direction orthogonal to the optical axis O with respect to the second lens holding frame 22 makes it possible to adjust the eccentric position of the first adjustment lens 212 held by the first adjustment frame 23 with respect to the reference lens 211 held by the second lens holding frame 22. After adjustment of the eccentric position, the screws 233 are accessed from the object side (front side) and rotated using a fastening tool to fasten the plurality of fastening parts 221 provided on the second lens holding frame 22 to the fastening parts 231 of the first adjustment frame 23.

FIG. 3B is an enlarged view of a part A illustrated in FIG. 3A. As illustrated in FIG. 3B, an inner diameter D1 of the through hole 232 of the first adjustment frame 23 is set to be larger to some extent than an inner diameter D2 of the female screw portion 222 of the second lens holding frame 22. Therefore, even if the first adjustment frame 23 is translated in the direction orthogonal to the optical axis O with respect to the second lens holding frame 22, the screws 233 can be fastened to the female screw portions 222 without interfering with the through holes 232.

Next, the relationship between the second adjustment frame 24 and the second lens holding frame 22 will be described.

The second adjustment frame 24 that holds the second adjustment lens 213 is held by the second lens holding frame 22 via the adjustment members 25 such that the second adjustment lens 213 is arranged closer to the image side than the reference lens 211 in the optical axis direction. The adjustment members 25 engage with adjustment member holding parts 223 provided on the outer periphery of the second lens holding frame 22. The pluralities of adjustment members 25 and adjustment member holding parts 223 (three each in this example) are arranged at substantially equal intervals on a circumference centered around the optical axis O. The adjustment member holding parts 223 extend from the second lens holding frame 22 toward the image side in the optical axis direction, and have a certain length along the optical axis direction in order to hold the adjustment members 25.

The adjustment member holding parts 223 and the above-described fastening parts 221 have certain lengths along the optical axis direction, and are arranged such that their phases do not overlap on a circumference as viewed from the optical axis direction. Therefore, the two adjustment mechanisms can be arranged without upsizing of the second lens holding frame 22.

Each adjustment member 25 has a cylindrical head part 251 centered around an axis extending radially in the direction orthogonal to the optical axis O, and an eccentric shaft part 252 centered around an axis eccentric from the central axis of the head part 251. The head part 251 has an operation portion 251a formed on its outer surface into which an adjustment tool is inserted to rotate the adjustment member 25 (see FIG. 2). The head part 251 is rotatably engaged in a press-fit state with a groove that is parallel to the optical axis O and is formed by regulating portions 223a and 223b of the adjustment member holding part 223. The eccentric shaft part 252 is eccentric with respect to the rotation center of the adjustment member 25. The eccentric shaft part 252 is rotatably engaged in a press-fit state with an adjustment member engagement part 241 of the second adjustment frame 24.

The operation portion 251a of the adjustment member 25 is accessed from the outside of the second lens unit 20 toward the optical axis O to rotate the adjustment member 25 by using an adjustment tool. When the adjustment member 25 is rotated, the head part 251 is regulated by the regulating portions 223a and 223b of the adjustment member holding part 223, so that a broken line C1 indicating the center of the eccentric shaft part 252 in FIG. 6A moves in the direction orthogonal to the optical axis O as illustrated by a solid line C2 in FIG. 6B. The movement of the eccentric shaft part 252 causes the adjustment member engagement part 241 engaged with the eccentric shaft part 252 to move in the same manner, and the second adjustment frame 24 provided with the adjustment member engagement part 241 moves in the direction orthogonal to the optical axis O with respect to the second lens holding frame 22. When two or more adjustment members 25 are operated, the second adjustment frame 24 can be moved to any position in a plane orthogonal to the optical axis O. In this manner, when the second adjustment frame 24 is translated with respect to the second lens holding frame 22 in the direction orthogonal to the optical axis O, the eccentric position of the second adjustment lens 213 held by the second adjustment frame 24 can be adjusted with respect to the reference lens 211 held by the second lens holding frame 22.

Each adjustment member 25 internally has a screw 253 as a fastening member. The screw 253 penetrates the head part 251 and the eccentric shaft part 252 in the axial direction of the eccentric shaft part 252, and can rotate independently of the head part 251 and the eccentric shaft part 252. The adjustment member engagement part 241 of the second adjustment frame 24 has a female screw portion 243 into which the screw 253 is screwed. The adjustment member engagement part 241 is an example of a second fixing part for fixing the second adjustment frame 24 to the second lens holding frame 22. After adjustment of the eccentric position of the second adjustment frame 24, the screw 253 is accessed from the outside and is rotated and fastened using a fastening tool to the female screw portion 243 of the adjustment member engagement part 241. Therefore, the eccentric position adjusted by the adjustment member 25 is fixed, so that the second adjustment frame 24 can be fixed to the second lens holding frame 22.

Since the second adjustment frame 24 is held by the second lens holding frame 22 via the adjustment members 25, the second adjustment frame 24 and the second lens holding frame 22 are not in direct contact with each other. There is a space provided between the second adjustment frame 24 and the second lens holding frame 22, allowing translation of the second adjustment frame 24.

The second adjustment frame 24 has a cylindrical extension part 242 that extends toward the object side centered around the optical axis O (see FIG. 3A). The extension part 242 is positioned so as to annularly cover from the outside the holding part 224 of the second lens holding frame 22 that holds the reference lens 211. That is, the extension part 242 is arranged so as to overlap with a part (holding part 224) of the second lens holding frame 22 as viewed from the direction orthogonal to the optical axis O. Therefore, even if the second lens holding frame 22 and the second adjustment frame 24 are not in direct contact with each other, it is possible to prevent intrusion of unnecessary light and dust in the vicinity of the optical axis O.

Next, the work of adjusting the eccentric position using the two adjustment mechanisms, the first adjustment frame 23 and the second adjustment frame 24, will be described.

The adjustment work is performed with the aperture unit 50 removed. Since the first adjustment frame 23 is arranged on the object side with respect to the second lens holding frame 22, it is possible to perform the eccentricity adjustment work by inserting a tool from the object side. On the other hand, the adjustment work of the second adjustment frame 24 is performed using the adjustment members 25 that are oriented in the direction orthogonal to the optical axis O centered around the optical axis O. Therefore, the eccentricity adjustment work can be performed by inserting a tool from the direction orthogonal to the optical axis O and rotating the adjustment members 25. In this manner, the two adjustment mechanisms provided in the second lens unit 20 can both be adjusted in one posture as illustrated in FIGS. 3A and 3B.

As illustrated in FIG. 4, the second lens holding frame 22 engages with the second group guiding member 27 and the second group rotation restricting member 28 at engagement parts 225 so as to be movable in the optical axis direction. The engagement parts 225 are arranged at different phases from the adjustment member holding parts 223 of the second lens holding frame 22 on a circumference centered around the optical axis O. As illustrated in FIG. 5, the third lens holding frame 32 engages with the second group guiding member 27 and the second group rotation restricting member 28 at engagement parts 321 so as to be movable in the optical axis direction.

The engagement parts 225 and the engagement parts 321 are both arranged in the same phase centered around the optical axis O with respect to the second group guiding member 27 and the second group rotation restricting member 28. Therefore, the third lens holding frame 32 can move in the optical axis direction without interfering with the adjustment members 25 and the adjustment member holding parts 223 that are long in the optical axis direction. The second lens holding frame 22 and the third lens holding frame 32 here can move independently, and can approach each other to a position where they partially overlap as viewed from the direction orthogonal to the optical axis O.

The engagement parts 225 and the engagement parts 321 are arranged so as not to overlap the adjustment members 25 as viewed from the optical axis direction. Therefore, the first adjustment frame 23 and the second adjustment frame 24 can move in the optical axis direction without upsizing of the lens barrel 100.

As described above, according to the present exemplary embodiment, the first adjustment frame 23, which is adjustable in the direction orthogonal to the optical axis O with respect to the second lens holding frame 22, is arranged on the object side in the optical axis direction with respect to the second lens holding frame 22. On the other hand, the second adjustment frame 24, which is adjustable in the direction orthogonal to the optical axis O with respect to the second lens holding frame 22, is arranged on the image side in the optical axis direction. In this manner, arranging the first adjustment frame 23 and the second adjustment frame 24 with the second lens holding frame 22 in between makes it possible to suppress interference between the two adjustment functions. Therefore, it is possible to suppress upsizing of the lens units and the lens barrel 100.

According to the present exemplary embodiment, the fastening parts 231 of the first adjustment frame 23 and the adjustment member engagement parts 241 of the second adjustment frame 24 are arranged so as not to overlap as viewed from the optical axis direction. Therefore, the first adjustment frame 23 and the second adjustment frame 24 can be fixed to the second lens holding frame 22 without upsizing of the second lens holding frame 22.

According to the present exemplary embodiment, the first adjustment frame 23 is held by the second lens holding frame 22, by being fastened with the plurality of screws 233 to the plurality of fastening parts 221 extending in the optical axis direction and provided on the second lens holding frame 22. On the other hand, the second adjustment frame 24 is held by the second lens holding frame 22 via the plurality of adjustment members 25. Therefore, even the two adjustment mechanisms can be adjusted in one posture.

According to the present exemplary embodiment, the screws 233 for fixing the first adjustment frame 23 to the second lens holding frame 22 and the screws 253 for fixing the second adjustment frame 24 to the second lens holding frame 22 can be accessed from mutually different directions. Therefore, the screws 233 and 253 can be easily positioned so as not to interfere with each other, which makes it possible to prevent upsizing of the lens barrel 100.

According to the present exemplary embodiment, each adjustment member 25 has a part that is rotatable about an axis line along the direction orthogonal to the optical axis O on the outer periphery of the second lens holding frame 22 and is eccentric with respect to the axis line. Therefore, rotating the adjustment members 25 makes it possible to adjust the eccentricity of the second adjustment frame 24.

According to the present exemplary embodiment, the second adjustment frame 24 has the cylindrical extension part 242 that extends toward the object side centered around the optical axis O, and the extension part 242 is arranged so as to overlap a part of the second lens holding frame 22 as viewed from the direction orthogonal to the optical axis O. Therefore, it is possible to prevent intrusion of unnecessary light and dust into the second lens holding frame 22 and the second adjustment frame 24 in the vicinity of the optical axis O.

As above, the present disclosure has been described in detail based on an exemplary embodiment thereof, but the invention is not limited to specific exemplary embodiments. The present disclosure also includes exemplary embodiments of various forms that do not deviate from the gist of the invention.

In the above-described exemplary embodiment, the adjustment members 25 are used to translate the second adjustment frame 24 with respect to the second lens holding frame 22 in the direction orthogonal to the optical axis O, but the invention is not limited to this method. The method for translating the second adjustment frame 24 with respect to the second lens holding frame 22 in the direction orthogonal to the optical axis O may be the same as the method for translating the first adjustment frame 23 with respect to the second lens holding frame 22 in the direction orthogonal to the optical axis O.

In the above-described exemplary embodiment, the female screw portions 222 and 243 may not have threads formed therein in advance, but may be formed by screwing the screws 233 and 253 to form threads. In addition, the fastening members are not limited to the screws 233 and 253, and may be rivets or the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-206966, filed Dec. 7, 2023, which is hereby incorporated by reference herein in its entirety.

What is claimed is:

1. A lens unit having a plurality of lenses, comprising:
a holding frame configured to hold a first lens among the plurality of lenses;
a first adjustment frame that is configured to hold a first adjustment lens among the plurality of lenses and is adjustable with respect to the holding frame in a direction orthogonal to an optical axis;
a second adjustment frame that is configured to hold a second adjustment lens among the plurality of lenses and is adjustable with respect to the holding frame in the direction orthogonal to the optical axis;
a first fixing part configured to fix the first adjustment frame to the holding frame; and
a second fixing part configured to fix the second adjustment frame to the holding frame,
wherein the first adjustment frame is arranged on an object side in an optical axis direction with respect to the holding frame,
wherein the second adjustment frame is arranged on an image side in the optical axis direction with respect to the holding frame, and
wherein the first fixing part and the second fixing part are arranged so as not to overlap each other as viewed from the optical axis direction.

2. The lens unit according to claim 1, further comprising:
a first fastening member configured to fix the first adjustment frame, which has been adjusted in the direction orthogonal to the optical axis, to the first fixing part; and
a second fastening member configured to fix the second adjustment frame, which has been adjusted in the direction orthogonal to the optical axis, to the second fixing part,
wherein the first fastening member and the second fastening member are accessible from mutually different directions.

3. The lens unit according to claim 1,
wherein the first adjustment frame is held by the holding frame by being fastened with a plurality of fastening members to a plurality of fastening parts that is provided on the holding frame and extends in the optical axis direction, and
wherein the second adjustment frame is held by the holding frame via a plurality of adjustment members.

4. The lens unit according to claim 3, wherein the adjustment members are rotatable about an axis line along the direction orthogonal to the optical axis on an outer periphery of the holding frame, and have a part that is eccentric to the axis line.

5. The lens unit according to claim 3,
wherein the fastening parts and the adjustment members are arranged at intervals on a circumference centered around the optical axis, and
wherein the fastening parts and the adjustment members are arranged so as not to overlap each other as viewed from the optical axis direction.

6. The lens unit according to claim 1,
wherein the second adjustment frame has a cylindrical extension part that extends toward the object side centered around the optical axis, and
wherein the extension part is arranged so as to overlap a part of the holding frame as viewed from the direction orthogonal to the optical axis.

7. The lens unit according to claim 1, wherein the holding frame is movable by a guide bar in the optical axis direction.

8. A lens barrel comprising:
a lens unit having a plurality of lenses, comprising:
a holding frame configured to hold a first lens among the plurality of lenses;
a first adjustment frame that is configured to hold a first adjustment lens among the plurality of lenses and is adjustable with respect to the holding frame in a direction orthogonal to an optical axis;
a second adjustment frame that is configured to hold a second adjustment lens among the plurality of lenses and is adjustable with respect to the holding frame in the direction orthogonal to the optical axis;
a first fixing part configured to fix the first adjustment frame to the holding frame; and
a second fixing part configured to fix the second adjustment frame to the holding frame,
wherein the first adjustment frame is arranged on an object side in an optical axis direction with respect to the holding frame,
wherein the second adjustment frame is arranged on an image side in the optical axis direction with respect to the holding frame, and
wherein the first fixing part and the second fixing part are arranged so as not to overlap each other as viewed from the optical axis direction; and
a second lens unit that is arranged on the image side of a first lens unit, the first lens unit being the lens unit,
wherein the first lens unit and the second lens unit are movable by the same guide bar in the optical axis direction.

9. The lens barrel according to claim 8, further comprising a plurality of the guide bars,
wherein the second adjustment frame is held by the holding frame via a plurality of adjustment members,
wherein the first lens unit and the second lens unit each have a plurality of engagement parts that is guided by the plurality of guide bars, and
wherein the plurality of engagement parts and the plurality of adjustment members are arranged so as not to overlap each other as viewed from the optical axis direction.

10. The lens barrel according to claim 8, wherein the first lens unit and the second lens unit are independently movable in the optical axis direction and are movable to positions where the first lens unit and the second lens unit partially overlap as viewed from the direction orthogonal to the optical axis.
